(19) United States
(12) Patent Application Publication
(10) Pub. No.: US 2009/0024919 A1
(43) Pub. Date: Jan. 22, 2009

(54) IMAGE FORMING APPARATUS TO SET ADDITIONAL EMULATION FUNCTIONS AND AN IMAGE PROCESSING METHOD THEREOF

(75) Inventors: Young-hee HUH, Ulsan (KR); Hye-jin Lee, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 12/052,933

(22) Filed: Mar. 21, 2008

(30) Foreign Application Priority Data
Jul. 18, 2007 (KR) 2007-71767

(51) Int. Cl. G06F 17/00

(52) U.S. Cl. 715/274; 715/273

(57) ABSTRACT

An image forming apparatus to set additional emulation functions includes a parsing unit to parse received print data and determine whether setting additional one or more emulation functions is necessary, and a control unit to provide a user interface (UI) to select the additional one or more emulation functions if a determination is made that setting the additional one or more emulation functions is necessary. Therefore, the user can set additional emulation functions necessary to print data using the UI with ease without checking and individually setting the additional emulation functions, and can set additional emulation functions according to personal needs, and thus user convenience is improved.

### CROSS-REFERENCE TO RELATED APPLICATIONS

This application claims priority under 35 U.S.C. §119(a) from Korean Patent Application No. 10-2007-0071767, filed on Jul. 18, 2007, in the Korean Intellectual Property Office, the disclosure of which is incorporated herein by reference in its entirety.

### BACKGROUND OF THE INVENTION

1. Field of the Invention

The present general inventive concept relates to an image forming apparatus to set additional emulation functions and an image processing method thereof. More particularly, the present general inventive concept relates to an image forming apparatus to provide a user interface (UI) to set additional emulation functions by determining whether additional emulation functions are necessary while print data are being parsed, and an image processing method thereof.

2. Description of the Related Art

Image forming apparatuses are apparatuses to print image data corresponding to an input original image onto recording media, such as paper. Examples of such image forming apparatuses include printers, copy machines, or facsimile machines.

In particular, manufacturers of printers use different printing methods to support modern printing data with diverse and brilliant colors.

Accordingly, printers have functions to process data according to a respective code of a printer so as to print data corresponding to the different codes, which are called emulation.

Recently, emulations widely used have been the printer control language (PCL), the page description language (PDL), the Korean PDL format (KS/KSSM), the graphic device interface (GDI) emulation using an operating system, and the like.

The emulation reads characteristics of print data while the print data are parsed, so as to optimize the print data to meet a user's needs by setting additional emulation functions.

The additional emulation functions include a setting for printing on wide paper, a setting for printing barcodes, a setting for skipping blank pages, and so on. Such additional emulation functions can read fixed print data, which cannot be amended, during the printing operation, and process and output the print data according to the user's needs.

The setting of additional emulation functions is required mainly in business-to-business (B2B) marketing. In B2B marketing, many forms of print data are used which are fixed in a mainframe without a driver. Market pressures require print data to be read, converted and output during printing operations according to a user's needs, instead of being amended, because the print data are fixed.

Such needs of the market have been solved by setting additional emulation functions.

For example, when fixed print data including a blank page are copied, if an additional emulation function for skipping blank paper is not set, the blank page is printed. However, a user likely does not wish to print the blank page. In this case, the user can set the additional emulation function for skipping blank pages, but most users do not know how to set such an additional emulation function. As a result, a method for easily setting additional emulation functions needs to be developed.

Conventionally, there are two methods for setting additional emulation functions. One is that users personally set additional emulation functions using a user interface (UI) for setting additional emulation functions provided in the image forming apparatus. However, since many users do not know about additional emulation functions, the users cannot use this method.

The other is that users generate a command for setting additional emulation functions in a host device, and transmit the command to the image forming apparatus. This method also requires user knowledge regarding print data and the setting of additional emulation functions.

As described above, setting additional emulation functions by conventional methods is difficult. Accordingly, an easy way to set additional emulation functions is required.

The present general inventive concept provides an easy way to set additional emulation functions, so the requirement to set additional emulation functions is addressed, user convenience is enhanced, and a burden on developers is reduced.

### SUMMARY OF THE INVENTION

The present general inventive concept provides an image forming apparatus to easily set additional emulation functions by determining whether additional emulation functions are necessary while print data are being parsed, and an image processing method thereof.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept may be achieved by providing an image forming apparatus including a parsing unit to parse received print data and determine whether setting additional one or more emulation functions is necessary, and a control unit to provide a user interface (UI) such that a user can select the additional one or more emulation functions if a determination is made that the additional one or more emulation functions need to be set.

The image forming apparatus may further include a display unit to display the UI, wherein the control unit sets the additional one or more emulation functions if the additional emulation function is selected using the UI.

The control unit may transmit information on the UI to a host device and displays thereon the transmitted information, and the control unit sets the additional one or more emulation functions if the additional one or more emulation functions is selected using the UI in the host device.

The control unit may provide a UI such that a user can select an operation mode, and the parsing unit determines whether setting the additional one or more emulation functions for the received print data is necessary only when a mode to set the additional one or more emulation functions is selected using the UI to select the operation mode.

The image forming apparatus may further include a rendering unit to render the parsed print data and convert the rendered print data into bitmap data, wherein the control unit operates the rendering unit to render the parsed print data according to a selected additional emulation function if the respective additional emulation function is selected using the UI.

The control unit may provide a sub-UI to select whether the selected additional emulation function is set as a default value, and sets the respective additional emulation function according to the selection in the sub-UI, the respective additional emulation function is selected using the UI.

The UI may include a first section to display a message informing a user of a necessity of setting the additional one or more emulation functions, a second section to select the additional one or more emulation functions, a third section to display information regarding the additional one or more emulation functions, and a fourth section to set the selected additional one or more emulation functions as default values.

The control unit may operate the parsing unit to process the print data page by page, wherein the additional emulation function settings include a setting to print on wide paper, a setting to skip blank pages, and a setting to print a barcode.

The control unit provides the UI if all print data are parsed.

The foregoing and/or other aspects and utilities of the present general inventive concept may be achieved by providing an image processing method of an image forming apparatus, the method including receiving and parsing print data, determining whether setting additional one or more emulation functions is necessary, and providing a user interface (UI) to select setting the one or more additional emulation functions if a determination is made that setting the additional one or more emulation functions is necessary.

The UI is provided through at least one of a display unit which is provided in the image forming apparatus, and a host device connected to the image forming apparatus.

The method may further include providing a UI to select an operation mode, wherein the determining operation is performed only when a mode to set the additional one or more emulation functions is selected using the UI to select the operation mode.

The method may further include printing the print data according to the selected one or more additional emulation functions if setting the respective additional emulation functions is selected using the UI.

The method may further include providing a sub-UI to select whether the selected additional emulation function is set as a default value if setting the respective additional one or more emulation functions is selected using the UI, and setting the respective additional one or more emulation functions according to the selection in the sub-UI.

The UI may include a first section to display a message informing a user of a necessity of setting the additional one or more emulation functions, a second section to select the additional one or more emulation functions, a third section to display information regarding the additional one or more emulation functions, and a fourth section to select whether to set the selected one or more additional emulation functions as default values.

In the receiving and passing the print data, the print data are processed page by page, wherein the additional emulation function settings include a setting to print on wide paper, a setting to skip blank pages, and a setting to print a barcode.

In the providing the UI, the UI is provided if all print data are parsed.

The foregoing and/or other aspects and utilities of the general inventive concept may also be achieved by providing an image forming apparatus including a parsing unit to parse received print data, and a controller to provide a user interface (UI) to set the one or more emulation functions to be added to one or more previously set emulation functions according to the parsed print data.

The parsing unit may determine one of a general mode to prevent the one or more additional emulation functions and an emulation mode to set the one or more additional emulation functions according to the parsed print data.

The one or more additional emulation functions may not overlap the previously set emulation functions.

The previously set emulation functions may be used to print previous print data.

The additional emulation functions may include a setting to print on wide paper and a setting to skip blank pages.

The controller may provide the user interface after one or more pages are parsed.

The foregoing and/or other aspects and utilities of the general inventive concept may also be achieved by providing a method of operating an image forming apparatus, the method including parsing received print data, and providing a user interface (UI) to allow a user to set the one or more emulation functions to be added to one or more previously set emulation functions according to the parsed print data.

The method may include determining one of a general mode to prevent the one or more additional emulation functions and an emulation mode to set the one or more additional emulation functions according to the parsed print data.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a block diagram illustrating an image forming apparatus according to an exemplary embodiment of the present general inventive concept;

FIG. 2 is a block diagram illustrating an image forming apparatus according to another exemplary embodiment of the present general inventive concept;

FIGS. 3 to 6 illustrate a user interface (UI) according to an exemplary embodiment of the present general inventive concept;

FIG. 7 is a flow chart illustrating an image processing method of an image forming apparatus according to an exemplary embodiment of the present general inventive concept; and

FIG. 8 is a flow chart illustrating an image processing method of an image forming apparatus according to another exemplary embodiment of the present general inventive concept.

### DETAILED DESCRIPTION OF THE PREFERRED EMBODIMENTS

Reference will now be made in detail to embodiments of the present general inventive concept, examples of which are illustrated in the accompanying drawings, wherein like reference numerals refer to like elements throughout. The embodiments are described below in order to explain the present general inventive concept by referring to the figures.

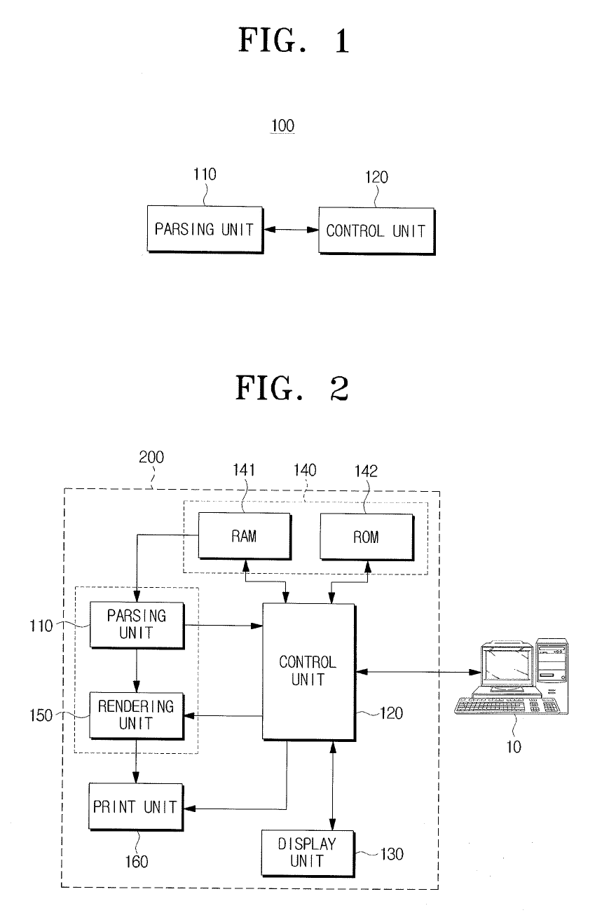

FIG. 1 is a block diagram illustrating an image forming apparatus according to an exemplary embodiment of the present general inventive concept. As illustrated in FIG. 1, the image forming apparatus 100 includes a parsing unit 110, and a control unit 120.

The parsing unit 110 parses print data received from a host device page by page. The parsing involves interpreting the print data, determining an operator, operand, and keyword in an emulation program defined by grammar of the emulation program, and analyzing constituents thereof.

The parsing unit 110 can output sentences interpreted by certain units by parsing the print data. Output data and interpreted sentences for each data may be called “Parsing Object Information” or “token,” but are referred to hereinbelow as “parsing data.”

The parsing data illustrates characteristics of data which will eventually be printed.

The parsing unit 110 determines the characteristics of the parsing data, and checks whether to set additional emulation functions. Only when a mode to set additional emulation functions is selected, can a determination be made whether additional emulation functions need to be set for the received print data. If additional emulation functions are not set, the image forming apparatus requests that the user set additional emulation functions.

Therefore, if a mode to set additional emulation functions is not selected, and for example, a general mode is selected instead, whether additional emulation functions need to be set is not determined while the received data are parsed, but the print data are instead converted directly into bitmap data.

For example, assuming that parsed print data are out of a printable area, a wide paper setting function is not set, and a mode to set additional emulation functions is selected, the wide paper setting function is displayed in a UI so that the user can set the wide paper setting function. If a general mode is selected, the above process is not performed, and print data out of the printable area are not printed.

The control unit 120 provides a UI to set additional emulation functions if a determination is made that additional emulation functions need to be set. The control unit 120 may provide the UI after one page of the print data is parsed or after all pages are parsed.

The additional emulation function settings include a setting to print on wide paper, a setting to skip blank paper, and a setting to print a barcode.

If additional emulation functions are set using the UI, the control unit 120 provides a sub-UI to select whether to set the selected additional emulation functions as default values.

The UI may include a first section to display a message informing of the necessity of setting additional emulation functions, a second section to select additional emulation functions, a third section to display information regarding the additional emulation functions, and a fourth section to select whether to set the additional emulation functions selected in the second section as default values.

The user does not need to check the print data and individually set each additional emulation function, but is provided with a UI displaying a list of additional emulation functions necessary to the print data, and can set additional emulation functions simply using the UI.

FIG. 2 is a block diagram illustrating an image forming apparatus according to another exemplary embodiment of the present general inventive concept. In FIG. 2, the image forming apparatus 200 includes a display unit 130, a storage unit 140, a rendering unit 150, and a print unit 160 in addition to the components illustrated in the configuration of the image forming apparatus 100 of FIG. 1. The image forming apparatus 200 may be connected to a host device 10 through the network.

The storage unit 140 includes a read-only memory (ROM) 142 to store diverse control programs to control the image forming apparatus 200, and a random-access memory (RAM) 141 to store a variety of temporary data generated to control the image forming apparatus 200.

The diverse control programs in the ROM 142 include a program to analyze a header of print data and determine an emulation mode of the print data, and a plurality of emulation programs to convert the print data into bitmap data.

The emulation programs may include printer control language (PCL), page description language (PDL), Korean PDL format (KS/KSSM), or graphic device interface (GDI) emulation.

The control unit 120 temporarily stores the print data received from the host device 10 in the RAM 141, and executes the program stored in the ROM 142 to analyze the header of the print data and determine the type of emulation.

The control unit 120 operates the parsing unit 110 to drive the determined emulation program and parse the print data.

The display unit 130 displays a UI provided by the control unit 120. Functions supported by the image forming apparatus 200 can be selected using the UI, and the UI displays an operational state of the selected function. In the present embodiment, a UI to set an operation mode of the image forming apparatus and a UI to set additional emulation functions can be displayed.

If an emulation mode is selected using the UI to set the operation mode of the image forming apparatus, the control unit 120 displays the UI to set additional emulation functions on the display unit 130 according to a result of parsing the print data. In addition, the control unit 120 transmits information regarding the UI to set additional emulation functions, and the host device 10 can display the UI.

If an additional emulation function is selected using the UI provided to the display unit 130 or the host device 10, the control unit 120 sets the additional emulation function.

The rendering unit 150 renders the parsed print data and converts the parsed print data to bitmap data. The rendering unit 150 generates the bitmap data to which the additional emulation function set by the control unit 120 is applied. That is, if the additional emulation function is selected using the UI, the print data are rendered according to the selected additional emulation function. The parsing unit 110 and the rendering unit 150 are driven by the same emulation program.

If the additional emulation function is selected using the UI to set additional emulation functions, the control unit 120 operates the rendering unit 150 and the print unit 160 to convert the print data into bitmap data and print the bitmap data. In addition, the control unit 120 provides a sub-UI to select whether to set the additional emulation function as default values.

If additional emulation function settings are set as default values using the sub-UI, the control unit 120 stores the selected additional emulation function settings in the RAM 141 or the ROM 142 as default values for the corresponding emulation type. If the additional emulation function settings are not set as default values, the selected additional emulation function is applied to only the print data.

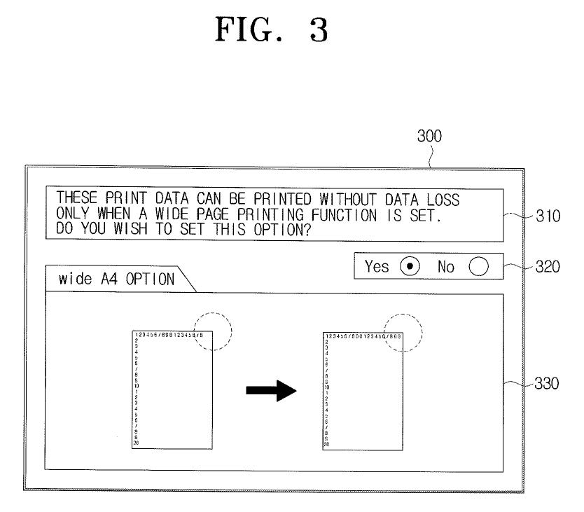

FIGS. 3 to 6 illustrate a user interface (UI) according to an exemplary embodiment of the present general inventive concept. FIG. 3 is a UI provided in a situation that a wide paper setting function is determined to be necessary during the parsing process. In FIG. 3, a UI to set additional emulation functions 300 may include a first section 310 to display a message informing the user of the need to set an additional emulation function, a second section 320 to select the additional emulation function, and a third section 330 to display information regarding the additional emulation function.

The third section 330 may provide information regarding the additional emulation function in image or text form, so the user can understand the additional emulation function.

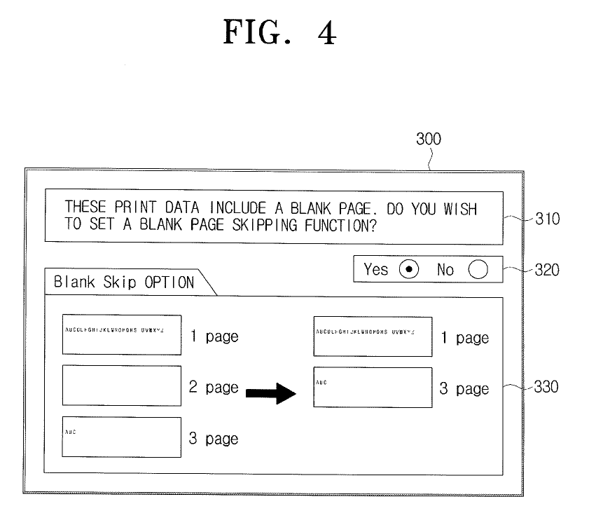

FIG. 4 is a UI to provide an additional emulation function to skip blank pages if one page is determined to be blank during the parsing process. For example, if print data of three pages are parsed separately page by page and the second page is determined to be blank, a UI is provided as illustrated in FIG. 4. If the user sets the additional emulation function to skip blank pages, the third page is parsed. If the user does not select the additional emulation function to skip blank pages, the parsed second page is printed and then subsequently the third page is printed.

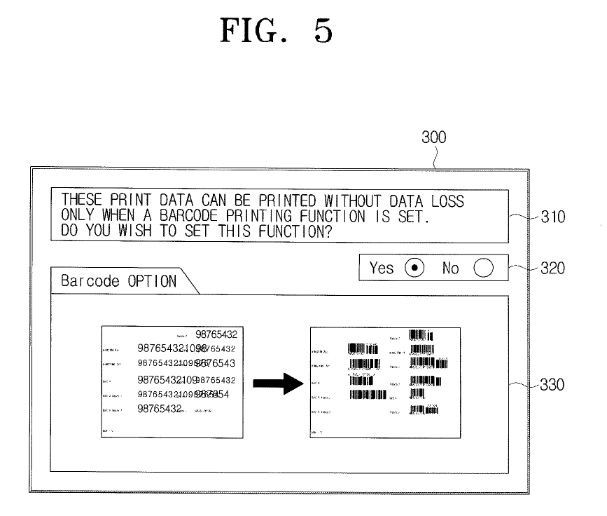

FIG. 5 is a UI to provide an additional emulation function to print a barcode. As illustrated in FIG. 5, if parsed print data includes a barcode, the print data can be printed without loss by setting the additional emulation function to print the barcode.

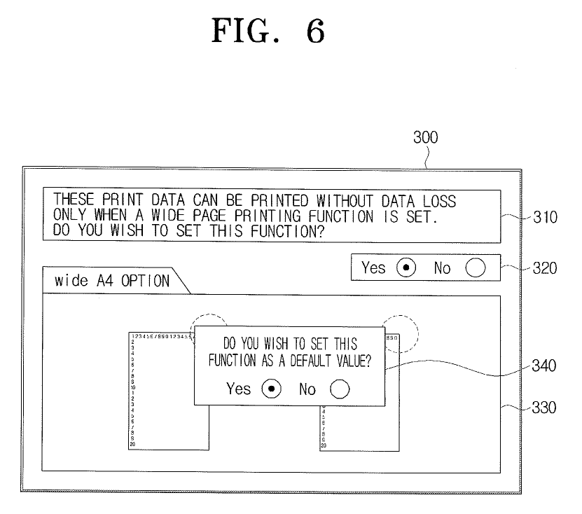

FIG. 6 illustrates in a fourth section 340 a sub-UI provided when an additional emulation function is selected using the UI to set additional emulation functions 300.

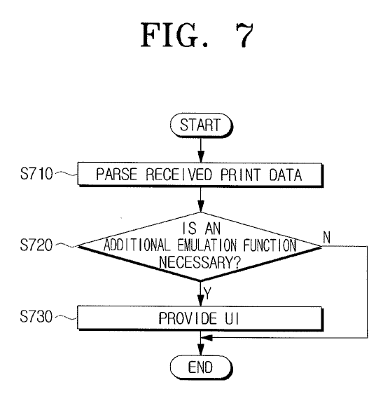

FIG. 7 is a flow chart illustrating an image processing method of an image forming apparatus according to an exemplary embodiment of the present general inventive concept. With reference to FIG. 7, in operation S710, received print data are parsed page by page. In operation S720, whether an additional emulation function is required to print data of a parsed page is determined.

The parsing involves interpreting the print data, determining the operator, operand, and keyword in an emulation program according to a definition of grammar of the emulation program, and analyzing the constituents thereof. Accordingly, eventually the characteristics of printed data become known.

Only when a mode to set additional emulation functions is selected, can a determination be made whether additional emulation functions for the received print data are necessary. Therefore, in a general mode, the received data are parsed, and converted directly into bitmap data.

If an additional emulation function is determined to be necessary, a UI is provided so the user may select the emulation addition function in operation S730.

The UI may be provided after one page of the print data is parsed or after all pages are parsed. The additional emulation functions settings include a setting to print on wide paper, a setting to skip blank pages, and a setting to print a barcode.

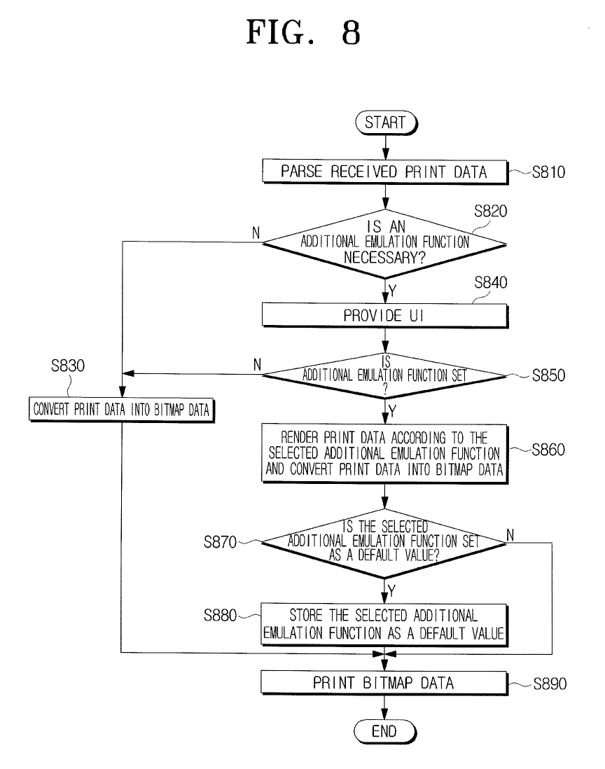

FIG. 8 is a flow chart illustrating an image processing method of an image forming apparatus according to another exemplary embodiment of the present general inventive concept. In FIG. 8, if an emulation mode is set, received print data are parsed page by page in operation S810. In operation S820, whether an additional emulation function is necessary is determined for each parsed page.

If a determination is made that an additional emulation function is not necessary, the parsed print data are converted into bitmap data in operation S830, and printed in operation S890.

If a determination is made that an additional emulation function is necessary, a UI to set the additional emulation function for the corresponding print data is provided in operation S840. The UI may be displayed on a display unit of the image forming apparatus, or transmitted to a host device and displayed thereon.

If setting an additional emulation function is selected using the UI in operation S850, the print data are rendered according to the selected additional emulation function and converted into bitmap data in operation S860. In addition, a sub-UI to select whether to set the additional emulation function settings as default values is provided.

The UI may include a first section to display a message informing the user of the need to an additional emulation functions, a second section to select additional emulation functions, a third section to display information regarding the additional emulation functions, and a fourth section to select whether to set any selected additional emulation functions settings as default values.

If the selected additional emulation functions are set as default values in operation S870, the selected additional emulation function value is stored as a default value, and the converted bitmap data are printed in operation S890. If the selected additional emulation function setting is not set as a default value in operation S870, the selected additional emulation function is applied only to the corresponding print data.

The present general inventive concept can also be embodied as computer-readable codes on a computer-readable medium. The computer-readable medium can include a computer-readable recording medium and a computer-readable transmission medium. The computer-readable recording medium is any data storage device that can store data that can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

Accordingly, the user does not need to check the print data and set the additional emulation functions individually, and instead is provided with a list of additional emulation functions necessary to print the data using the UI, and can set additional emulation functions more simply.

As described above, various embodiments of the present general inventive concept provide a UI to set additional emulation functions by determining whether additional emulation functions are necessary while print data are being parsed. Therefore, the user can simply set additional emulation functions necessary to print data using the UI more easily without individually checking and setting the additional emulation functions, and can set additional emulation functions according to personal needs, and thus user convenience is improved.

Although various embodiments of the present general inventive concept have been illustrated and described, it will be appreciated by those skilled in the art that changes may be made in these embodiments without departing from the principles and spirit of the general inventive concept, the scope of which is defined in the appended claims and their equivalents.

What is claimed is:

1. An image forming apparatus, comprising:
a parsing unit to parse received print data and determine whether setting additional one or more emulation functions is necessary; and
a control unit to provide a user interface (UI) such that a user can select the additional one or more emulation functions if a determination is made that the additional one or more emulation functions need to be set.

2. The image forming apparatus of claim 1, further comprising:
a display unit to display the UI,
wherein the control unit sets the additional one or more emulation functions if the additional one or more emulation functions is selected using the UI.

3. The image forming apparatus of claim 1, wherein the control unit transmits information on the UI to a host device and displays thereon the transmitted information, and the control unit sets the additional one or more emulation functions if the additional one or more emulation functions is selected using the UI in the host device.

4. The image forming apparatus of claim 1, wherein the control unit provides a UI such that a user can select an operation mode, and the parsing unit determines whether setting the additional one or more emulation functions for the received print data is necessary only when a mode to set the additional one or more emulation functions is selected using the UI to select the operation mode.

5. The image forming apparatus of claim 1, further comprising:
a rendering unit to render the parsed print data and convert the rendered print data into bitmap data,
wherein the control unit operates the rendering unit to render the parsed print data according to the selected additional one or more emulation functions if the respective additional one or more emulation functions is selected using the UI.

6. The image forming apparatus of claim 5, wherein the control unit provides a sub-UI to select whether the selected additional one or more emulation functions is set as a default value, and sets the additional respective one or more emulation functions according to the selection in the sub-UI, the respective additional one or more emulation functions is selected using the UI.

7. The image forming apparatus of claim 1, wherein the UI comprises:
a first section to display a message informing a user of a necessity of setting the additional one or more emulation functions, a second section to select the additional one or more emulation functions, a third section to display information regarding the additional one or more emulation functions, and a fourth section to set the selected one or more additional emulation functions as default values.

8. The image forming apparatus of claim 1, wherein the control unit operates the parsing unit to process the print data page by page such that the additional emulation function settings comprise a setting to print on wide paper, a setting to skip blank pages, and a setting to print a barcode.

9. The image forming apparatus of claim 1, wherein the control unit provides the UI if all print data are parsed.

10. An image processing method of an image forming apparatus, the method comprising:
receiving and parsing print data;
determining whether setting additional one or more emulation functions is necessary; and
providing a user interface (UI) to select setting the additional one or more emulation functions if a determination is made that setting the additional one or more emulation functions is necessary.

11. The method of claim 10, wherein in the providing the UI, the UI is provided through at least one of a display unit which is provided in the image forming apparatus, and a host device connected to the image forming apparatus.

12. The method of claim 10, further comprising:
providing a UI to select an operation mode,
wherein the determining operation is performed only when a mode to set the additional one or more emulation functions is selected using the UI to select the operation mode.

13. The method of claim 10, further comprising:
printing the print data according to the selected one or more additional emulation functions if setting the respective additional one or more emulation functions is selected using the UI.

14. The method of claim 10, further comprising:
providing a sub-UI to select whether the selected one or more additional emulation functions is set as a default value if setting the respective additional one or more emulation functions is selected using the UI; and
setting the respective additional emulation function according to the selection in the sub-UI.

15. The method of claim 10, wherein the UI comprises:
a first section to display a message informing a user of a necessity of setting the additional emulation functions;
a second section to select the additional one or more emulation functions;
a third section to display information regarding the additional one or more emulation functions; and
a fourth section to select whether to set the selected additional one or more emulation functions as default values.

16. The method of claim 10, wherein in the receiving and parsing the print data, the print data are processed page by page,
wherein the additional one or more emulation functions settings comprise a setting to print on wide paper, a setting to skip blank pages, and a setting to print a barcode.

17. The method of claim 10, wherein in the providing the UI, the UI is provided if all print data are parsed.

18. An image forming apparatus, comprising:
a parsing unit to parse received print data; and
a controller to provide a user interface (UI) to set one or more emulation functions to be added to one or more previously set emulation functions according to the parsed print data.

19. The image forming apparatus of claim 18, wherein the parsing unit determines one of a general mode to prevent the one or more additional emulation functions and an emulation mode to set the one or more additional emulation functions according to the parsed print data.

20. The image forming apparatus of claim 18, wherein the one or more additional emulation functions do not overlap the previously set emulation functions.

21. The image forming apparatus of claim 18, wherein the previously set emulation functions are used to print previous print data.

22. The image forming apparatus of claim 18, wherein the emulation functions comprise:
a setting to print on wide paper; and
a setting to skip blank pages.

23. The image forming apparatus of claim 18, wherein the controller provides the user interface after one or more pages are parsed.

24. A method of operating an image forming apparatus, the method comprising:
parsing received print data; and
providing a user interface (UI) to set one or more emulation functions to be added to one or more previously set emulation functions according to the parsed print data.

25. The method of claim 24, wherein determining one of a general mode to prevent the one or more additional emulation functions and an emulation mode to set the one or more additional emulation functions according to the parsed print data.
